(19) United States
(12) Patent Application Publication
(10) Pub. No.: US 2017/0285916 A1
(43) Pub. Date: Oct. 5, 2017

(54) CAMERA EFFECTS FOR PHOTO STORY GENERATION

(71) Applicants: Yan Xu, Santa Clara, CA (US); Maha El Choubassi, San Jose, CA (US); Ronald T. Azuma, San Jose, CA (US); Oscar Nestares, San Jose, CA (US)

(72) Inventors: Yan Xu, Santa Clara, CA (US); Maha El Choubassi, San Jose, CA (US); Ronald T. Azuma, San Jose, CA (US); Oscar Nestares, San Jose, CA (US)

(21) Appl. No.: 15/085,677

(22) Filed: Mar. 30, 2016

(51) Int. Cl. G06F 3/0484; G06T 11/00; G06T 7/00; G06T 3/00; G06T 5/00

(52) U.S. Cl. CPC G06F 3/04845; G06T 3/0093; G06F 3/04842; G06T 5/002; G06T 7/0081; G06T 11/001

(57) ABSTRACT

Embodiments of a system and method for applying camera effects to an image are generally described herein. A method may include receiving, at a device, information including an image and depth data of pixels of the image, generating a set of candidate regions of interest in the image, receiving a user selection of a region of interest of the set of candidate regions of interest, and generating a camera effect for the image using the region of interest and the depth data. The method may include outputting an augmented image, outputting information, outputting a video, or the like.

### BACKGROUND

Photos tell stories. However, static photos make it difficult to direct a viewer's attention to specific aspects of the static photos. To address this problem, and to make photos look more alive, some existing photo techniques apply camera panning and zooming effects, which are often known as the “Ken Burns effect.” However, these methods treat photos as flat objects and they do not take into consideration the geometry in the underlying scene represented in the image. This limits the ways that users may express their stories in photos. As a result, viewers of photos miss out on geometrical aspects of photos.

A second problem with the existing photo techniques is that they either offer too little control or are too complicated to use. For example, professional photography software has lots of camera effects, but requires expertise in photo manipulation to use the software. Other tools are easier to use, but have extremely limited choices in camera effects. Currently no techniques allow non-expert users to choose among camera effects and create images using the chosen camera effect.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a block diagram showing a system for generating an augmented image in accordance with some embodiments.

FIG. 2 illustrates a block diagram showing a system for generating saliency scores for segments of an image in accordance with some embodiments.

FIG. 3 illustrates an interface including selected regions of interest with corresponding durations of interest of an image in accordance with some embodiments.

FIGS. 4A-4B illustrate augmented images with blur camera effects in accordance with some embodiments.

FIG. 5A illustrates an image without camera effects and FIG. 5B illustrates an augmented image with a pan/zoom camera effect in accordance with some embodiments.

FIG. 6 illustrates a dolly zoom camera effect on an augmented image in accordance with some embodiments.

FIG. 7 illustrates a color effect on an image in accordance with some embodiments.

FIG. 8 illustrates a flowchart showing a technique for generating an output including a camera effect and an image in accordance with some embodiments.

FIG. 9 illustrates generally an example of a block diagram of a machine upon which any one or more of the techniques (e.g., methodologies) discussed herein may perform in accordance with some embodiments.

### DETAILED DESCRIPTION

Systems and methods for applying camera effects to an image are described herein. In an example, a system provides an expressive photo tour of an image, tailored to pleasantly emphasize the scene content and personalized to a user's taste. 3D data from photos captured using depth enabled devices may be used to create personalized photos. A rich set of languages for camera movement and manipulations may be created using the depth data. Image processing techniques may be used to analyze image content and identify important parts in a scene and determine how they may be clustered or segmented. The systems and methods described herein may present these features without relying on a user's precise camera manipulation to make the photo tour look meaningful and professional. A user may provide minimal input to indicate a region or regions of interest rather than tracing the outline of these regions. In an example, a semi-automated process may automate tedious tasks of understanding photo scenes and segmenting them, using minimal input from a user. The systems and methods described herein may be much more enjoyable and easy for casual users.

The systems and methods described herein provide ease-of-use for users, may provide more expressiveness and more meaningful photo tours for users, or provide a small file size to enable sharing and re-sharing. In an example, color and depth (RGBD) data may be used with image processing techniques to analyze scene content and identify salient parts in the scene and how they may be clustered or segmented. User interaction may be reduced to simple tapping or dragging actions. When regions of interest are selected by a user, the system may provide a rich set of camera effects for the user to express a story and add more aliveness to the scene. In another example, a photo tour may be created without any user input. The top salient regions may be selected automatically and visual effects may be applied on them.

Systems and methods described herein allow users that have little or no prior experience in photo/video editing techniques to create photos or videos with camera effects. In existing techniques, a lightfield capturing device is used to enable refocusing and parallax. However, this technique results in large file sizes and difficulty in use. Lightfield cameras are not in widespread use among the public and are rather used by niche specialized research teams. In the systems and methods described herein, RGBD data may be used rather than a stack of lightfield images as input. The RGBD data may be captured and computed using more commonly available commercial devices. In the systems and methods described herein, an agnostic approach to the sources of RGBD data is taken; the source may be from an active or a passive depth sensing camera.

In an example, a user may first select a sequence of regions of interest or a visual effect. In another example, using scene analysis, candidate areas of interest that a user may easily select, are created. The user selections may be made without a significant amount of time spent by the user to make the selection precise. Further, a set of visual effects may be implemented that a user may try, including providing results after the selection for preview.

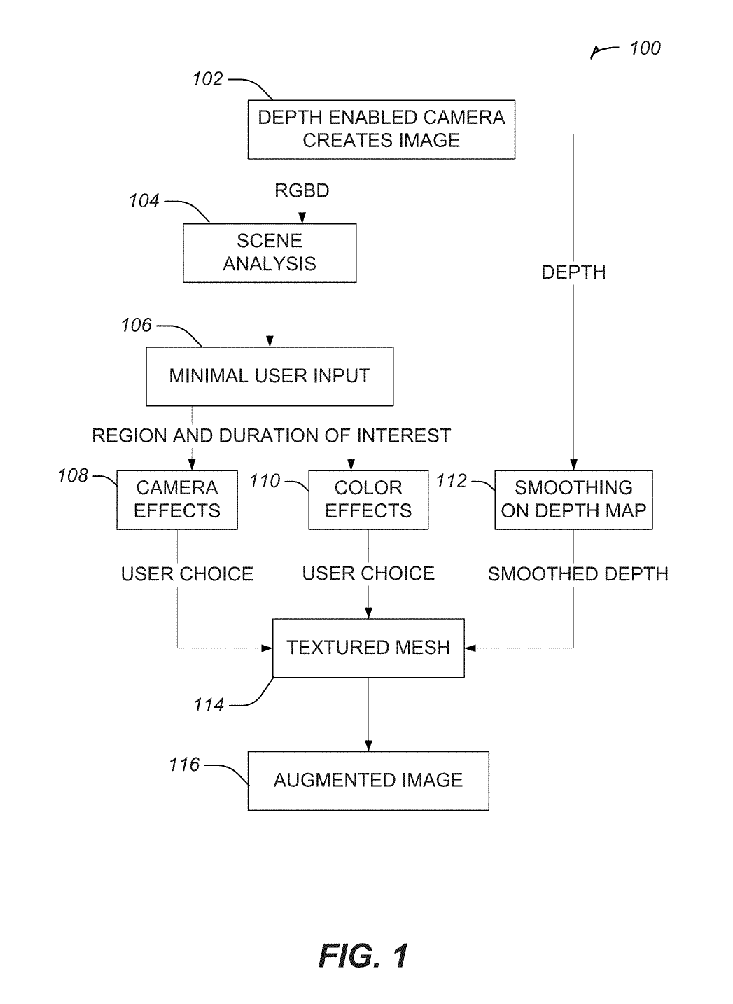

FIG. 1 illustrates a block diagram showing a system 100 for generating an augmented image in accordance with some embodiments. The system 100 accepts an input of an image and a depth map, such as RGBD data, for example, data captured by a depth-enabled camera device at block 102. The system 100 may, in an example, output a sharable file that conveys the story teller's intention and visual effects choices. This file may be flexible, such that it may be edited again and re-shared, by the initial user or by a later user. The file may be treated not as two dimensional media, but as 3D media. Block 102 of the system 100 includes a depth enabled camera to create an image including depth information. The information created by the camera may include image data, color data, and depth data, such as RGBD data. The system 100 includes a block 104 to receive the RGBD data from block 102. The system 100 may include a block 112 to receive the depth data or the image, which may be optionally used in the system 100.

Block 104 includes a scene analyzer to perform a scene analysis. After the photo is captured by, or received from, a depth-enabled camera, the RGBD data may be received for each of the pixel in the image, or for a set of pixels at the scene analyzer 104. The scene analyzer may generate a candidate set of regions of interest from the depth data. For example, the scene analysis may include saliency analysis, face detection, or segmentation. The candidate regions of interest may be sent to block 106. The scene analyzer may include memory and processing circuitry. The scene analyzer may run a facial recognition process to determine if faces are present in an image. The scene analyzer may run a segmentation process or a saliency analysis to determine coherent entities in an image, such as a face, a person, an animal, a tree, a car, a house, a building, a street, etc. In another example, the scene analyzer may determine sets of pixels corresponding to regions of interest and a set of pixels corresponding to background pixels.

Block 106 includes a user interface to receive user input. The user input may include user interaction design. In an example, a casual user may not have the time or skills to edit photos into a video, but the casual user may easily use a touch screen or input device to mark areas of interest to the casual user on the user interface. When the touch or input is not accurate enough to cover a region of interest or directly touch a region of interest, interest areas may be refined using the results from the scene analyzer at block 104 to determine a region of interest the user intended to select using the input on the user interface. For example, the system 100 may use block 106 to determine that a user input has been received including a selection on a display within a predetermined distance of an edge of a region of interest on the user interface. The selected region or regions of interest may be sent to blocks 108 or 110 for effects.

The system 100 includes a block 108 including a camera effect component to apply one or more camera effects to the image. The camera effect component may use the depth data to build a geometry or map of the scene depicted in the image. Many different 3D camera effects may be implemented using the camera effect component, such as parallax, dolly zoom, Ken Burns effect, focus shift, refocus, insert new objects, remove objects from the image, such as when the camera moves, or the like. The camera effect component may, for example, apply a blur on an image in a pixel-by-pixel basis using depth data of each pixel to determine whether to blur that pixel. The camera effect component may, for example, compare depth data for a pixel, stored in memory, to a range to determine whether or how much to blur the pixel. The resulting blurred pixel may be stored in memory and compiled with the remaining pixels to form a new image, that may be stored. The camera effect component may include a comparator, a pixel adjustment component to change the color, intensity, etc., of a pixel, memory, and a communication component to receive or output images or image data.

The system 100 may include a block 110 including a color effect component to apply one or more color effects to the image. The color effect component may apply color effects before, after, or concurrently with the camera effects applied by the camera effect component of block 108. A color effect may be used to apply different moods to the image. The color effects may be applied on a generated photo tour by the color effect component. Global color effect filters may be applied, or color effect may be applied based on regions of interest or depth data by the color effect component. Color effects may be combined with other camera effects described above to enhance the output image. For example, if a user wants to focus on a first person as a region of interest, the user may choose to apply a color effect just on that region of interest (or in another example, on the remaining aspects of the image other than the region of interest) to highlight that region of interest. Other color effects may include sketches, color blocks, color shifts, making an image cartoonish, or the like. The color effect component may load a raster image into a working memory buffer. A filter, alpha channel adjustment, clip opacity, or other image processing technique may be applied by the color effect component on a pixel-by-pixel basis to a portion of the raster image. A resulting image may be output by the color effect component for later use or presentation. The color effect component may include a color adjuster, memory, and a communication component to receive or output images or image data.

The system 100 may use the user interface to provide a list of candidate options for the camera effects or color effects to a user. For example, a list of possibilities may be presented on the user interface, and a user may select or preselect a camera effect or a color effect. Multiple camera or multiple color effects may be used simultaneously.

In an example, the system 100 may include a block 112 including a smoothing component to run a smoothing operation on a depth map of the image. The smoothing component may be used to smooth noise in a depth map. A raw depth map may be cured so that the camera effects applied by the camera effect component may be visually pleasant without annoying artifacts. In an example, filtered depth values may be determined by minimizing regularized depth filtering error at the smoothing component. In another example, the smoothing component may adapt the filtering process to the content of a scene in the image. Other smoothing techniques may be used by the smoothing component. In yet another example, block 112 may be skipped or determined to be unnecessary, and may not be used by the system 100.

The system 100 includes a textured mesh component to receive and compile results from block 108 and optionally from blocks 110 or 112. The textured mesh component may apply a textured mesh to the image. For example, a mesh may be based on the smoothed depth map from the smoothing component. The mesh created by the textured mesh component may be a regular grid mesh or a dynamic mesh depending on the density of information in the scene in the image, for example, using the scene with the camera effects applied by the camera effect component. In an example, a regular mesh may be used. In another example, a mesh fine enough to capture the smallest depth details in the scene may be used. In yet another example, a mesh using dynamically adapted mesh resolution may be used, with the mesh resolution varying with respect to an amount of local depth variation. For example, regions of an image that are more flat may not need such a fine mesh, and the mesh may be coarser at those regions. At regions with greater depth details, the mesh may be finer to capture the additional details.

The system 100 includes a block 116 including an output component to present, output, display, or save an augmented image. For example, the augmented image may include a sharable photo tour. In an example, a story may be presented from a single photo, and a user may share the story, such as on social media, using the output component. In another example, an augmented image may be generated from the sequence of effects on photos (e.g., from blocks 108 or 110). The augmented image may be exported to a variety of formats using the output component, including a video file, a GIF file, a series of files, a unique file format, a flexible format that includes time-stamped camera parameter sequences together with RGBD data from the original capture (e.g., from block 102), or the like. The flexible format, compared to a video, may enable a user to generate a unique own story with other photos as well as allowing a user to re-share a new story generated using other photos.

The system 100 may use the output component to determine and store an event timeline, such as timestamps corresponding to images, frames, camera effects, color effects, etc. The augmented image may include a RGBD image file and the timestamps or a sequence of camera parameters, which may be decoded by a viewer. The augmented image may use an encoding/decoding system, such as a script, an application, a mobile app, or a web app to view the augmented image. The output component may generate a dynamic augmented image, such as one that may be changed by a viewer or secondary user. For example, the timestamp data, camera parameters, camera effects, or color effects may be changed by a viewer or a secondary user (e.g., edited) after being created by a first user using the system 100. The augmented image may be created using a standard format, implemented with depth information and images. For example, a standard “depth-image” file type may be used.

The system 100 provides a set of blocks, which may be at least partially used by an application to generate a story from a static photo. The story may capture a user's intention or expression through multiple visual effects (e.g., camera effects or color effects of the camera effect component or the color effect component respectively). A technique may use the system 100 to give a user a rich vocabulary of visual effects (e.g., camera effects or color effects of the camera effect component or the color effect component respectively) to express a story. The system 100 allows a user to create the story without a significant time or effort commitment by using scene analysis.

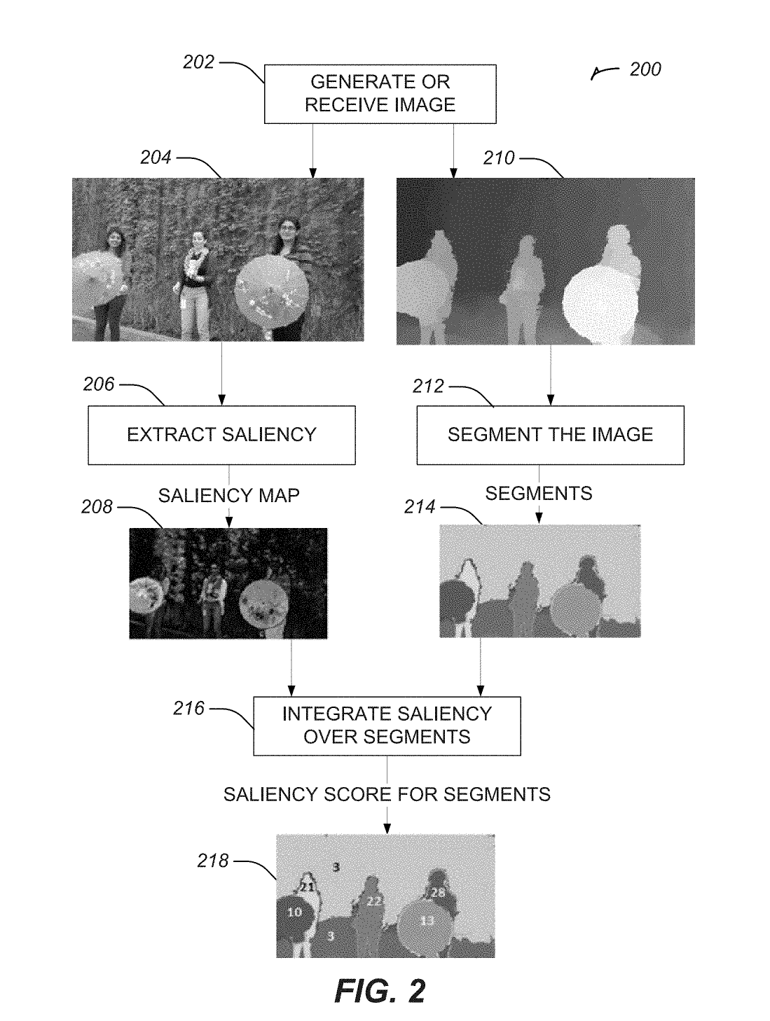

FIG. 2 illustrates a block diagram showing a system 200 for generating saliency scores for segments of an image in accordance with some embodiments. The system 200 is used to create, generate, or identify candidate regions of interest, such as for use in technique 100 for scene analysis in operation 104. Scene analysis may include saliency analysis or segmentation. For example, an input may include a RGBD image or information from an image including RGBD information. The system 200 may output candidate regions of interest. The candidate regions of interest may be sorted, such as by an importance score for each region of interest, linearly, according to color, based on height, or the like.

As shown in FIG. 2, the system 200 includes using the RGBD image or information at block 202 as an input and outputting the candidate regions of interest at block 218. The system 200 includes block 202 to generate or receive an image, such as image 204. Image 204 represents a raw image or an image without saliency or segmentation done. A depth map of image 204 is shown as depth map image 210. The depth map image 210 may be determined from the image 204 or received as information from block 202. Image 204 may include information for creating image 210.

Image 204 may be used to extract saliency at block 206. The saliency extraction at block 206 results in a saliency map image 208. To extract the saliency map from the image 204 at block 206, any saliency technique may be used. For example, various heuristics may be used to extract saliency from image 204, such as human faces as salient regions, regions that have a large depth difference compared to a background, or the like. Saliency may be dependent on predetermined features of interest, such as faces, people, animals, specified attributes, etc. In another example, saliency may be dependent on depth data, such as selecting pixels that have a large depth difference compared to a background as having higher saliency. For cases with strict computational limitations, sparse salient points may be detected instead of determining a dense saliency map. For example, pixel groups or representative pixels may be used to determine saliency.

In operation 212, system 200 may segment the depth map image 210 to determine segment regions. For example, image 210 may be segmented using RGBD data into meaningful segments, such as depending on color or depth difference among the pixels. Techniques to segment the image 210 may result in image segments as shown in segmented image 214.

The saliency map image 208 and the segmented image 214 may be used together to integrate saliency found in the saliency map image 208 over the segments of the segmented image 214 at block 216. The integrated saliency map and segmented regions may be used to select top k areas with highest saliency values at block 216. For example, a saliency score for each segment or a plurality of segments of the image 204 may be determined. In an example, the saliency scores may be ranked, the segments may be presented with raw scores or ranked scores, or the image may include a subset of the segments, such as including those that scored above or below a threshold. The segmented areas with a saliency score above a threshold may include a candidate set of salient regions. The candidate set of salient regions may include saliency scores for the regions, and may be presented, such as in ranked saliency score image 218 of system 200. The ranked saliency score image 218 may include segment scores as shown in FIG. 2, which may represent relative importance of the regions compared to other regions in the image. For example, ranked saliency score image 218 includes three regions with scores of 21, 22, and 28 respectively, which represent the people identified in the saliency map and the segmented regions of images 204 and 210. These three regions may include candidate regions of interest, such as for use in the technique 100 of FIG. 1 at operations 104 and 106.

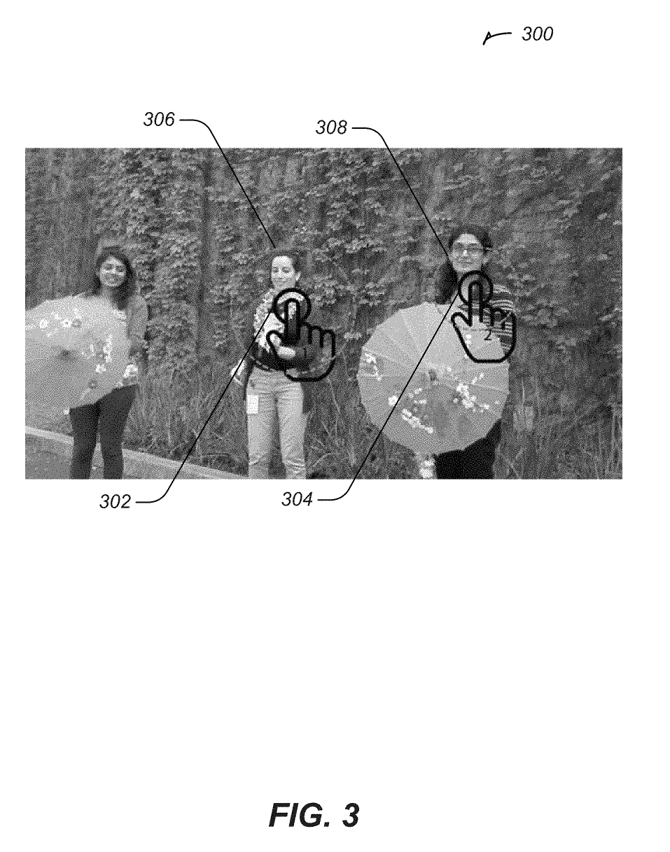

FIG. 3 illustrates an interface 300 including selected regions of interest with corresponding durations of interest of an image in accordance with some embodiments. The interface 300 includes a first indication 302 and a second indication 304. The indications 302 and 304 include respective duration indications, including a first duration indication 306 for the first indication 302 and a second duration indication 308 for the second indication 304. The indications 302 and 304 correspond with attempted selections of candidate regions of interest, such as those determined using system 200 of FIG. 2.

In an example, the indications 302 and 304 may be propagated to be a region of interest from the candidate regions of interest. For example, the first indication 302 may include the area within an outline of a person and in response to receiving the first indication 302, the image may be displayed with the region of interest corresponding to the person highlighted or otherwise shown as selected. The interface 300 avoids having a user trace the outline of the region of interest (e.g., the person). Moreover, the interface 300 allows for imprecision from the user, as the indications 302 or 304 may be made near, around, or at the regions of interest without necessarily being directly on the region of interest or tracing entirely around the region of interest. The user may be a novice or inexperienced with image manipulation or creation. When the first indication 302 or the second indication 304 tap is mistakenly not directly within a region of interest, the interface 300 may determine the attempted selection of a particular region of interest to correct the error. For example, the closest candidate with the highest saliency region may be selected automatically.

The first duration indication 306 and the second duration indication 308 may correspond with a user selected duration of interest in the respective regions of interest determined from the indications 302 and 304. In an example, the duration indications 306 and 308 may be mapped from a duration that a user maintains a finger press, mouse button click, keystroke, or other input in the region of interest. In an example, the first user indication 302 may be selected concurrently with the first duration of interest 306, such as by receiving a single input with a location and a duration of input. The duration of interests 306 and 308 may be mapped in real time and displayed at the interface 300, such as by expanding a circle around the input as shown at the duration of indications 306 and 308.

The interface 300 may receive the first indication 302 and the second indication 304 as ordered selections. In an example, the first indication 302 may be used for a first camera effect and the second indication 304 may be used for a second camera effect. For example, the eventual output may include a focus/refocus camera effect to first focus on the region of interest corresponding to the first indication 302 and then refocus on the region of interest corresponding to the second indication 304. The time between focus and refocus may be determined by one or both of the duration indications 306 or 308. In another example, one or both of the duration indications 306 or 308 may be used to order the focus/refocus camera effect. For example, if the duration indication 306 as shown in FIG. 3 is larger than the duration of interest 308, the region of interest corresponding to the duration indication 306 may be prioritized first or put in focus first, and the region of interest corresponding to the duration indication 308 may be prioritized second or put in focus second. Other camera effects described above may use the indications 302 or 304 or the duration indications 306 or 308 for similar selections, prioritizing, or the like. In another example, the color effects described above may use the indications 302 or 304 or the duration indications 306 or 308 for similar selections, prioritizing, or the like.

In yet another example, the interface 300 may receive a duration indication without receiving a region of interest indication (e.g., indications 302 and 304). The duration indication received in this way may be used similarly to the duration indications 306 and 308. For example, the top k regions of interest from candidate regions of interest that are generated from the scene analysis may be used with the duration indication to generate camera or color effects.

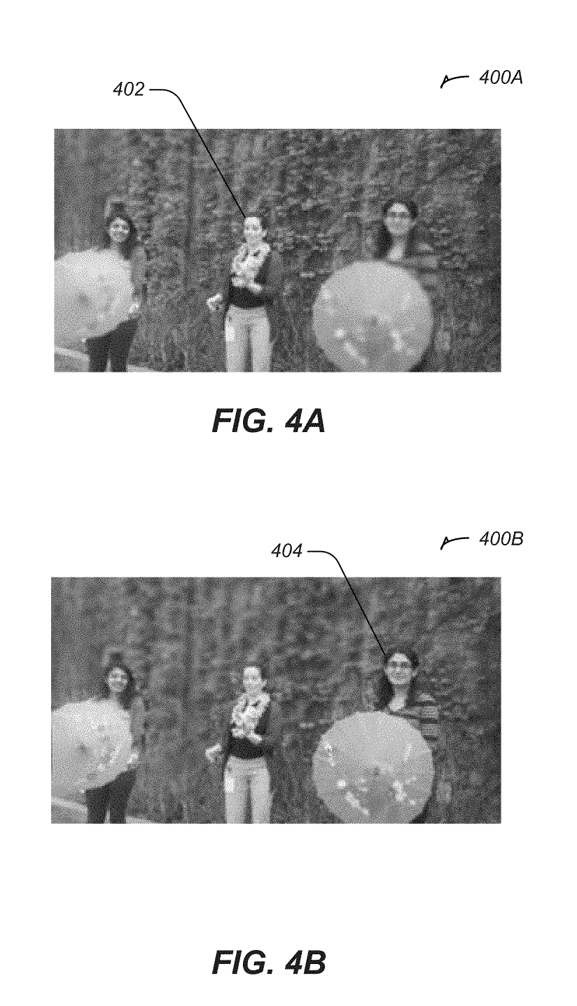

FIGS. 4A-4B illustrate augmented images 400A and 400B with camera blur effects in accordance with some embodiments. Augmented image 400A shows a camera blur effect created by applying a shallow depth-of-field camera effect focusing on region of interest 402. Augmented image 400B shows that the camera blur effect is shifted to a different region of interest 404. In an example, augmented images 400A and 400B may result from a single image with regions of interest 402 and 404 as two of a plurality of candidate regions of interest. Regions of interest 402 and 404 may be selected, such as using interface 300 of FIG. 3.

The augmented images 400A and 400B show the focus shift camera effect when viewed together. For example, the augmented images 400A and 400B may be included in a video, GIF file, or specifically formatted file type and viewed in sequence. For example, according to user input, such as the indications 302 and 304 of FIG. 3, the camera focus shifts from the region of interest 402 to the region of interest 404. The depth of focus in between these two images 400A and 400B may be interpolated to allow for a smooth transition.

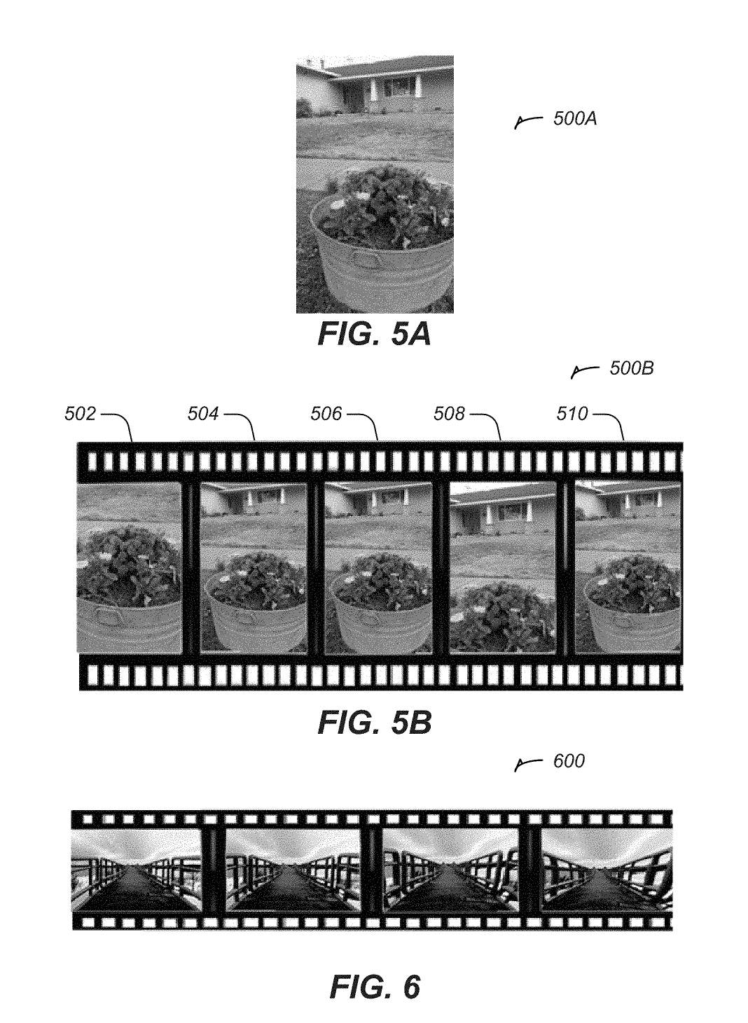

FIG. 5A illustrates an image 500A without camera effects and FIG. 5B illustrates an augmented image 500B with a pan/zoom camera effect in accordance with some embodiments. When a user wants to tell a story with a photo in person, the user may naturally point at different parts of the photo and talk about them. However, this is not possible with traditional static photos, such as image 500A. Using augmented image 500B, a viewer's attention may be directed from one part of the augmented image 500B to another, and the static photo image 500A becomes a vivid story as an augmented image 500B. The augmented image 500B may be created using the technique 100 of FIG. 1 to display camera or color effects. The augmented image 500B may allow for remote viewing of a story with the user present or without requiring the user to actively control the story. In another example, the augmented image 500B allows a second user to retell the story or create a new story. For example, image 500A was taken to tell a story about how Californians deal with drought. However, viewers may easily miss the point when looking at the static image 500A. Augmented image 500B, in contrast to image 500A, includes a sequence of images (e.g., a generated video story). Augmented image 500B first focuses on colorful flowers by setting the background to be black-and-white and blurred in frame 502. The augmented image 500B then zooms out the camera in frame 504. The augmented image 500B recovers the color in frame 506, and focuses on the background to reveal the brown lawns in frame 508, before returning to a full view to wrap up the story in frame 510. The image 500A and augmented image 500B may be generated from RGBD image data, such as data captured by a depth camera.

FIG. 6 illustrates a dolly zoom camera effect on an augmented image 600 in accordance with some embodiments. The dolly zoom camera effect is a camera technique to convey a sensation of vertigo or a feeling of unreality. The dolly zoom camera effect creates the unsettling feeling in a user by challenging the human vision system. The dolly zoom camera effect changes the perspective and size of objects in an unnatural way. For example, to show that a person in a video is shocked, the camera may move closer to the subject, and widen the field of view at the same time. This effect is different from how human eyes function, and may cause a feeling or emotional response in a viewer.

The dolly zoom camera effect is an advanced camera technique and traditionally required a professional photographer, since it requires moving a camera, changing a field of view (e.g., zooming), and refocusing on a subject of an image at the same time. Amateurs are not able to replicate the effect of a dolly zoom using limited equipment. In typical video production, a complicated setup is required for a dolly zoom effect during movie making.

In the augmented image 600, a dolly zoom effect may be simulated on an image without a professional photographer, expensive equipment, or a complicated camera setup. The dolly zoom effect may be implemented in the augmented image 600 as a post capture camera effect. In an example, a user may select the center of an image, such as using interface 300 of FIG. 3, for a dolly zoom effect. A duration indication or drag of the input may control how much the camera moves along a z dimension. The augmented image 600 illustrates simulated movement of a camera, change in a field of view, and refocus of a dolly zoom effect implemented, for example, using the technique 100 of FIG. 1. The simulated dolly zoom effect resulting in augmented image 600 may be output as a video, GIF file, specially formatted file type, or the like, such that a viewer may experience the changing effect of the dolly zoom.

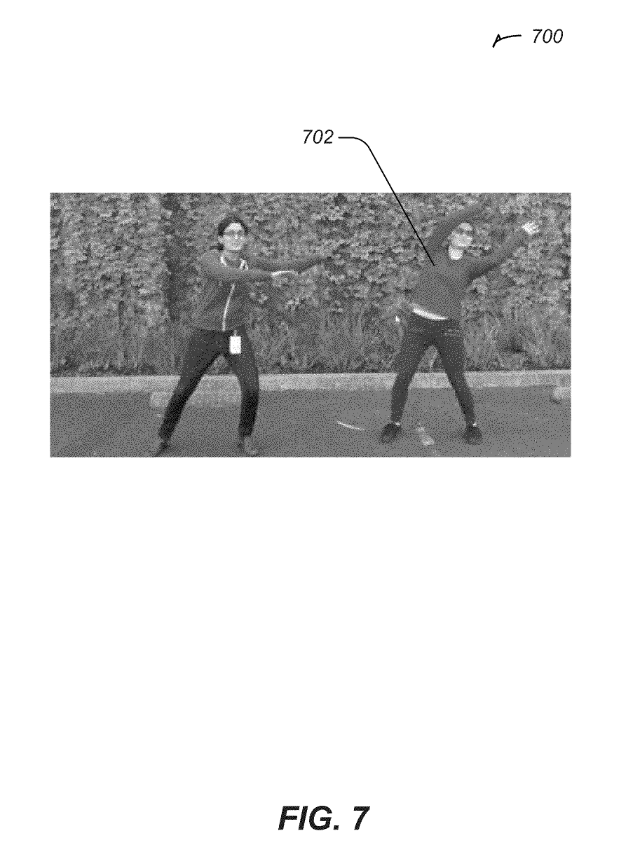

FIG. 7 illustrates a color effect on an image 700 in accordance with some embodiments. The color effect shown on image 700 includes a black-and-white filter, applied to change the image 700 to include a color portion region of interest 702 and a black and white portion in the remaining image. The region of interest 702 may be selected, such as described above. The image 700 may include a noise filter to reduce noise in the image. The color effect applied to image 700 may be combined with camera effects as described above to enhance the image 700. For example, if a user wants to focus on the region of interest 702, the region of interest 702 may be selected and a color effect may be applied just on the region of interest 702. In another example, a color effect may be applied on remaining portions of the image other than the region of interest 702.

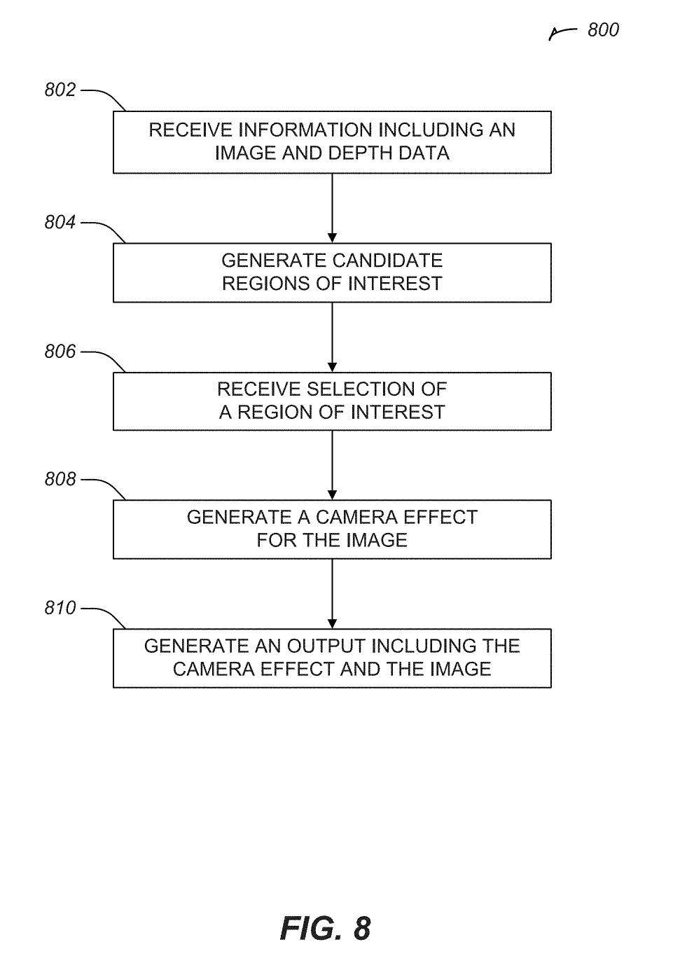

FIG. 8 illustrates a flowchart showing a technique 800 for generating an output including a camera effect and an image in accordance with some embodiments. The technique 800 includes an operation 802 to receive information including an image and depth data. For example, the depth data may include pixel depth data for pixels in the image, such as RGBD data.

The technique 800 includes an operation 804 to generate a set of candidate regions of interest. In an example, generating the set of candidate regions of interest may include using a saliency analysis. The saliency analysis may include facial detection. In another example, generating the set of candidate regions of interest may include performing segmentation using depth difference of depth data.

The technique 800 includes an operation 806 to receive selection of a region of interest from the candidate regions of interest, for example, by receiving a user selection, such as on a display. Receiving the selection may include receiving a selection on a display within a predetermined distance of an edge of the region of interest. In another example, receiving the selection may include receiving a duration of interest. The duration of interest may be used to prioritize the region of interest over a second region of interest, such as a second received selected region of interest. In yet another example, the duration of interest may correspond to a duration of a user input on the region of interest on a display.

The technique 800 includes an operation 808 to generate a camera effect for the image. In an example, the camera effect may be user selected. In another example, the camera effect may include at least one of parallax, Ken Burns effect, focus, defocus, refocus, object insertion, object removal, or a dolly zoom.

The technique 800 may include an operation to generate a color effect for the image. The technique 800 may include an operation to remove noise from the depth data by minimizing regularized depth filtering errors to create a smoothed depth map. The technique 800 may include an operation to generate a textured mesh using the smoothed depth map.

The technique 800 includes an operation 810 to generate an output including the camera effect and the image. In an example, the output is an augmented image, such as a file in a GIF format. In another example, the output is an augmented image including the image, a series of camera effect parameter sequences including timestamps corresponding to changes in the camera effect, and the depth data.

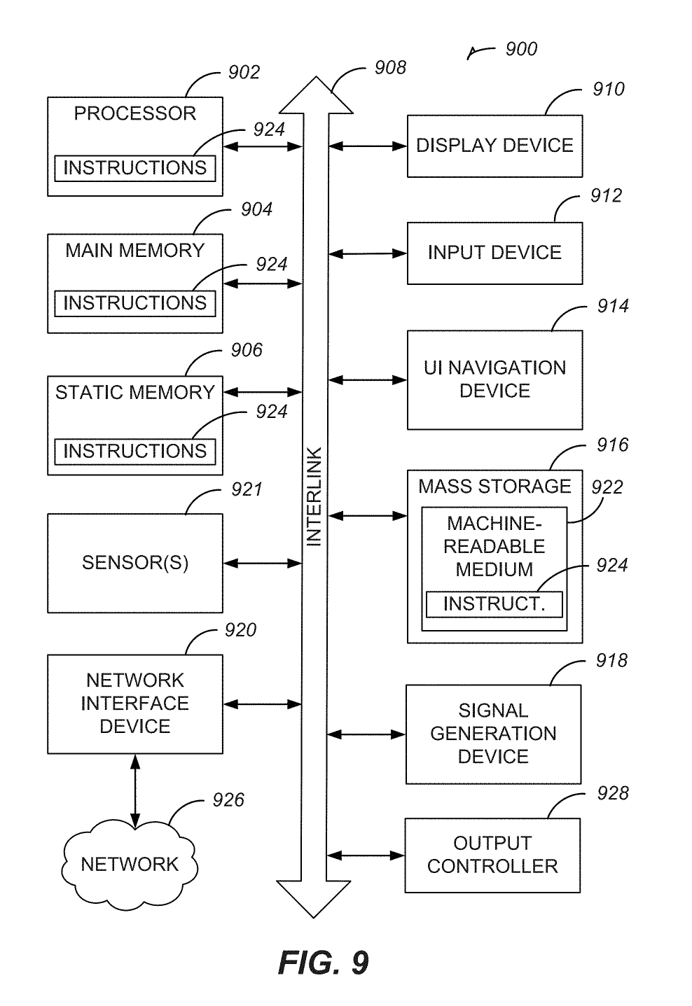

FIG. 9 illustrates generally an example of a block diagram of a machine 900 upon which any one or more of the techniques (e.g., methodologies) discussed herein may perform in accordance with some embodiments. In alternative embodiments, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in peer-to-peer (P2P) (or other distributed) network environment. The machine 900 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 900 may include a hardware processor 902 (e.g., a central processing unit (CPU), a graphics processing unit (GPU), a hardware processor core, or any combination thereof), a main memory 904 and a static memory 906, some or all of which may communicate with each other via an interlink (e.g., bus) 908. The machine 900 may further include a display unit 910, an alphanumeric input device 912 (e.g., a keyboard), and a user interface (UI) navigation device 914 (e.g., a mouse). In an example, the display unit 910, alphanumeric input device 912 and UI navigation device 914 may be a touch screen display. The machine 900 may additionally include a storage device (e.g., drive unit) 916, a signal generation device 918 (e.g., a speaker), a network interface device 920, and one or more sensors 921, such as a global positioning system (GPS) sensor, compass, accelerometer, or other sensor. The machine 900 may include an output controller 928, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 916 may include a machine readable medium 922 that is non-transitory on which is stored one or more sets of data structures or instructions 924 (e.g., software) embodying or utilized by any one or more of the techniques or functions described herein. The instructions 924 may also reside, completely or at least partially, within the main memory 904, within static memory 906, or within the hardware processor 902 during execution thereof by the machine 900. In an example, one or any combination of the hardware processor 902, the main memory 904, the static memory 906, or the storage device 916 may constitute machine readable media.

While the machine readable medium 922 is illustrated as a single medium, the term “machine readable medium” may include a single medium or multiple media (e.g., a centralized or distributed database, or associated caches and servers) configured to store the one or more instructions 924.

The term “machine readable medium” may include any medium that is capable of storing, encoding, or carrying instructions for execution by the machine 900 and that cause the machine 900 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 924 may further be transmitted or received over a communications network 926 using a transmission medium via the network interface device 920 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 920 may include one or more physical jacks (e.g., Ethernet, coaxial, or phone jacks) or one or more antennas to connect to the communications network 926. In an example, the network interface device 920 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 900, and includes digital or analog communications signals or other intangible medium to facilitate communication of such software.

### VARIOUS NOTES & EXAMPLES

Each of these non-limiting examples may stand on its own, or may be combined in various permutations or combinations with one or more of the other examples.

Example 1 is a system for applying camera effects to an image, the system comprising: a scene analyzer to: receive a depth image from a depth camera, the depth image including depth data of pixels of the depth image; and generate a set of candidate regions of interest in the depth image; a user interface to receive a user selection of a region of interest of the set of candidate regions of interest; a camera effect component to generate a camera effect for the depth image using the region of interest and the depth data; and an output component to output an augmented image including the camera effect from the depth image.

In Example 2, the subject matter of Example 1 optionally includes wherein the scene analyzer is to generate the set of candidate regions of interest using a saliency analysis.

In Example 3, the subject matter of Example 2 optionally includes wherein the saliency analysis includes facial detection.

In Example 4, the subject matter of any one or more of Examples 1-3 optionally include wherein to generate the set of candidate regions of interest, the scene analyzer is to perform segmentation using depth data.

In Example 5, the subject matter of any one or more of Examples 1-4 optionally include wherein to receive the user selection, the user interface is to receive a selection within a predetermined distance of an edge of the region of interest.

In Example 6, the subject matter of any one or more of Examples 1-5 optionally include wherein to receive the user selection, the user interface is to receive a duration of interest.

In Example 7, the subject matter of Example 6 optionally includes wherein the scene analyzer is to use the duration of interest to prioritize the region of interest over a second region of interest selected by the user.

In Example 8, the subject matter of any one or more of Examples 6-7 optionally include wherein the duration of interest corresponds to a duration of a user input on the region of interest on the user interface.

In Example 9, the subject matter of any one or more of Examples 1-8 optionally include a smoothing component to remove noise from the depth data by minimizing regularized depth filtering errors to create a smoothed depth map.

In Example 10, the subject matter of Example 9 optionally includes wherein the smoothing component is to generate a textured mesh using the smoothed depth map.

In Example 11, the subject matter of any one or more of Examples 1-10 optionally include wherein the camera effect is user selected.

In Example 12, the subject matter of any one or more of Examples 1-11 optionally include wherein the camera effect includes at least one of parallax, Ken Burns effect, focus, defocus, refocus, object insertion, and object removal.

In Example 13, the subject matter of any one or more of Examples 1-12 optionally include wherein the camera effect includes a dolly zoom.

In Example 14, the subject matter of any one or more of Examples 1-13 optionally include a color effect component to generate a color effect for the image.

In Example 15, the subject matter of any one or more of Examples 1-14 optionally include wherein the augmented image is a file in a GIF format.

In Example 16, the subject matter of any one or more of Examples 1-15 optionally include wherein the augmented image includes the image, a series of camera effect parameter sequences including timestamps corresponding to changes in the camera effect, and the depth data.

Example 17 is a method for applying camera effects to an image, the method comprising: receiving, at a device, information including an image and depth data of pixels of the image; generating a set of candidate regions of interest in the image; receiving a user selection of a region of interest of the set of candidate regions of interest; generating a camera effect for the image using the region of interest and the depth data; and outputting an augmented image including the camera effect.

In Example 18, the subject matter of Example 17 optionally includes wherein generating the set of candidate regions of interest includes using a saliency analysis.

In Example 19, the subject matter of Example 18 optionally includes wherein the saliency analysis includes facial detection.

In Example 20, the subject matter of any one or more of Examples 17-19 optionally include wherein generating the set of candidate regions of interest includes performing segmentation using depth data.

In Example 21, the subject matter of any one or more of Examples 17-20 optionally include wherein receiving the user selection includes receiving a selection on a display within a predetermined distance of an edge of the region of interest.

In Example 22, the subject matter of any one or more of Examples 17-21 optionally include wherein receiving the user selection includes receiving a duration of interest.

In Example 23, the subject matter of Example 22 optionally includes using the duration of interest to prioritize the region of interest over a second region of interest selected by the user.

In Example 24, the subject matter of any one or more of Examples 22-23 optionally include wherein the duration of interest corresponds to a duration of a user input on the region of interest on a display.

In Example 25, the subject matter of any one or more of Examples 17-24 optionally include removing noise from the depth data by minimizing regularized depth filtering errors to create a smoothed depth map.

In Example 26, the subject matter of Example 25 optionally includes generating a textured mesh using the smoothed depth map.

In Example 27, the subject matter of any one or more of Examples 17-26 optionally include wherein the camera effect is user selected.

In Example 28, the subject matter of any one or more of Examples 17-27 optionally include wherein the camera effect includes at least one of parallax, Ken Burns effect, focus, defocus, refocus, object insertion, and object removal.

In Example 29, the subject matter of any one or more of Examples 17-28 optionally include wherein the camera effect includes a dolly zoom.

In Example 30, the subject matter of any one or more of Examples 17-29 optionally include generating a color effect for the image.

In Example 31, the subject matter of any one or more of Examples 17-30 optionally include wherein the augmented image is a file in a GIF format.

In Example 32, the subject matter of any one or more of Examples 17-31 optionally include wherein the augmented image includes the image, a series of camera effect parameter sequences including timestamps corresponding to changes in the camera effect, and the depth data.

Example 33 is at least one machine-readable medium including instructions for operation of a computing system, which when executed by a machine, cause the machine to perform operations of any of the methods of Examples 17-32.

Example 34 is an apparatus comprising means for performing any of the methods of Examples 17-32.

Example 35 is at least one machine-readable medium including instructions for operation of a computing system, which when executed by a machine, cause the machine to perform operations to: receive, at a device, information including an image and depth data of pixels of the image; generate a set of candidate regions of interest in the image; receive a user selection of a region of interest of the set of candidate regions of interest; generate a camera effect for the image using the region of interest and the depth data; and output an augmented image including the camera effect.

In Example 36, the subject matter of Example 35 optionally includes wherein to generate the set of candidate regions of interest includes to generate the set of candidate regions of interest using a saliency analysis.

In Example 37, the subject matter of Example 36 optionally includes wherein the saliency analysis includes facial detection.

In Example 38, the subject matter of any one or more of Examples 35-37 optionally include wherein to generate the set of candidate regions of interest includes to perform segmentation using depth data.

In Example 39, the subject matter of any one or more of Examples 35-38 optionally include wherein to receive the user selection includes to receive a selection on a display within a predetermined distance of an edge of the region of interest.

In Example 40, the subject matter of any one or more of Examples 35-39 optionally include wherein to receive the user selection includes to receive a duration of interest.

In Example 41, the subject matter of Example 40 optionally includes operations to use the duration of interest to prioritize the region of interest over a second region of interest selected by the user.

In Example 42, the subject matter of any one or more of Examples 40-41 optionally include wherein the duration of interest corresponds to a duration of a user input on the region of interest on a display.

In Example 43, the subject matter of any one or more of Examples 35-42 optionally include operations to remove noise from the depth data by minimizing regularized depth filtering errors to create a smoothed depth map.

In Example 44, the subject matter of Example 43 optionally includes operations to generate a textured mesh using the smoothed depth map.

In Example 45, the subject matter of any one or more of Examples 35-44 optionally include wherein the camera effect is user selected.

In Example 46, the subject matter of any one or more of Examples 35-45 optionally include wherein the camera effect includes at least one of parallax, Ken Burns effect, focus, defocus, refocus, object insertion, and object removal.

In Example 47, the subject matter of any one or more of Examples 35-46 optionally include wherein the camera effect includes a dolly zoom.

In Example 48, the subject matter of any one or more of Examples 35-47 optionally include operations to generate a color effect for the image.

In Example 49, the subject matter of any one or more of Examples 35-48 optionally include wherein the augmented image is a file in a GIF format.

In Example 50, the subject matter of any one or more of Examples 35-49 optionally include wherein the augmented image includes the image, a series of camera effect parameter sequences including timestamps corresponding to changes in the camera effect, and the depth data.

Example 51 is an apparatus for applying camera effects to an image, the apparatus comprising: means for receiving, at a device, information including an image and depth data of pixels of the image; means for generating a set of candidate regions of interest in the image; means for receiving a user selection of a region of interest of the set of candidate regions of interest; means for generating a camera effect for the image using the region of interest and the depth data; and means for outputting an augmented image including the camera effect.

In Example 52, the subject matter of Example 51 optionally includes wherein the means for generating the set of candidate regions of interest include means for using a saliency analysis.

In Example 53, the subject matter of Example 52 optionally includes wherein the saliency analysis includes facial detection.

In Example 54, the subject matter of any one or more of Examples 51-53 optionally include wherein the means for generating the set of candidate regions of interest include means for performing segmentation using depth data.

In Example 55, the subject matter of any one or more of Examples 51-54 optionally include wherein the means for receiving the user selection include means for receiving a selection on a display within a predetermined distance of an edge of the region of interest.

In Example 56, the subject matter of any one or more of Examples 51-55 optionally include wherein the means for receiving the user selection include means for receiving a duration of interest.

In Example 57, the subject matter of Example 56 optionally includes means for using the duration of interest to prioritize the region of interest over a second region of interest selected by the user.

In Example 58, the subject matter of any one or more of Examples 56-57 optionally include wherein the duration of interest corresponds to a duration of a user input on the region of interest on a display.

In Example 59, the subject matter of any one or more of Examples 51-58 optionally include means for removing noise from the depth data by minimizing regularized depth filtering errors to create a smoothed depth map.

In Example 60, the subject matter of Example 59 optionally includes means for generating a textured mesh using the smoothed depth map.

In Example 61, the subject matter of any one or more of Examples 51-60 optionally include wherein the camera effect is user selected.

In Example 62, the subject matter of any one or more of Examples 51-61 optionally include wherein the camera effect includes at least one of parallax, Ken Burns effect, focus, defocus, refocus, object insertion, and object removal.

In Example 63, the subject matter of any one or more of Examples 51-62 optionally include wherein the camera effect includes a dolly zoom.

In Example 64, the subject matter of any one or more of Examples 51-63 optionally include means for generating a color effect for the image.

In Example 65, the subject matter of any one or more of Examples 51-64 optionally include wherein the augmented image is a file in a GIF format.

In Example 66, the subject matter of any one or more of Examples 51-65 optionally include wherein the augmented image includes the image, a series of camera effect parameter sequences including timestamps corresponding to changes in the camera effect, and the depth data.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A system for applying camera effects to an image, the system comprising:
a scene analyzer to:
receive a depth image from a depth camera, the depth image including depth data of pixels of the depth image; and
generate a set of candidate regions of interest in the depth image;
a user interface to receive a user selection of a region of interest of the set of candidate regions of interest;
a camera effect component to generate a camera effect for the depth image using the region of interest and the depth data; and
an output component to output an augmented image including the camera effect from the depth image.

2. The system of claim 1, wherein the scene analyzer is to generate the set of candidate regions of interest using a saliency analysis.

3. The system of claim 2, wherein the saliency analysis includes facial detection.

4. The system of claim 1, wherein to generate the set of candidate regions of interest, the scene analyzer is to perform segmentation using depth data.

5. The system of claim 1, wherein to receive the user selection, the user interface is to receive a selection within a predetermined distance of an edge of the region of interest.

6. The system of claim 1, wherein to receive the user selection, the user interface is to receive a duration of interest.

7. The system of claim 6, wherein the scene analyzer is to use the duration of interest to prioritize the region of interest over a second region of interest selected by the user.

8. The system of claim 6, wherein the duration of interest corresponds to a duration of a user input on the region of interest on the user interface.

9. The system of claim 1, further comprising a smoothing component to remove noise from the depth data by minimizing regularized depth filtering errors to create a smoothed depth map.

10. The system of claim 9, wherein the smoothing component is to generate a textured mesh using the smoothed depth map.

11. The system of claim 1, wherein the camera effect is user selected.

12. The system of claim 1, wherein the camera effect includes at least one of parallax, Ken Burns effect, focus, defocus, refocus, object insertion, and object removal.

13. The system of claim 1, wherein the camera effect includes a dolly zoom.

14. The system of claim 1, further comprising a color effect component to generate a color effect for the image.

15. The system of claim 1, wherein the augmented image is a file in a GIF format.

16. The system of claim 1, wherein the augmented image includes the image, a series of camera effect parameter sequences including timestamps corresponding to changes in the camera effect, and the depth data.

17. A method for applying camera effects to an image, the method comprising:
receiving, at a device, information including an image and depth data of pixels of the image;
generating a set of candidate regions of interest in the image;
receiving a user selection of a region of interest of the set of candidate regions of interest;
generating a camera effect for the image using the region of interest and the depth data; and
outputting an augmented image including the camera effect.

18. The method of claim 17, wherein generating the set of candidate regions of interest includes using a saliency analysis.

19. The method of claim 18, wherein the saliency analysis includes facial detection.

20. The method of claim 17, wherein generating the set of candidate regions of interest includes performing segmentation using depth data.

21. At least one machine-readable medium including instructions for operation of a computing system, which when executed by a machine, cause the machine to:
receive, at a device, information including an image and depth data of pixels of the image;
generate a set of candidate regions of interest in the image;
receive a user selection of a region of interest of the set of candidate regions of interest;
generate a camera effect for the image using the region of interest and the depth data; and
output an augmented image including the camera effect.

22. The at least one machine-readable medium of claim 21, further comprising instructions to remove noise from the depth data by minimizing regularized depth filtering errors to create a smoothed depth map.

23. The at least one machine-readable medium of claim 21, wherein the camera effect is user selected.

24. The at least one machine-readable medium of claim 21, wherein the camera effect includes at least one of parallax, Ken Burns effect, focus, defocus, refocus, object insertion, and object removal.

25. The at least one machine-readable medium of claim 21, wherein the camera effect includes a dolly zoom.
